(19) United States
(12) Patent Application Publication
(10) Pub. No.: US 2024/0001682 A1
(43) Pub. Date: Jan. 4, 2024

(54) LIQUID DISCHARGING APPARATUS

(71) Applicant: BROTHER KOGYO KABUSHIKI KAISHA, Nagoya (JP)

(72) Inventor: HARUHISA SHIRAI, Kasugai (JP)

(73) Assignee: BROTHER KOGYO KABUSHIKI KAISHA, Nagoya (JP)

(21) Appl. No.: 18/334,419

(22) Filed: Jun. 14, 2023

(30) Foreign Application Priority Data
Jun. 30, 2022 (JP) 2022-105650

(51) Int. Cl. B41J 2/17

(52) U.S. Cl. CPC B41J 2/1721; B41J 2002/1728

(57) ABSTRACT

There is provided a liquid discharging apparatus including: a housing; a head including a nozzle configured to discharge a liquid to a printing medium; a waste liquid reservoir configured to store a waste liquid of the liquid, the waste liquid reservoir being configured to be inserted into and drawn from the housing; and a conveying route via which the printing medium is to be conveyed in a conveying direction. In a state that the waste liquid reservoir is inserted in the housing, the waste liquid reservoir is arranged in an inside of the housing, and at a position upstream of the head in the conveying direction and above the conveying route.

### REFERENCE TO RELATED APPLICATIONS

This application claims priority from Japanese Patent Application No. 2022-105650 filed on Jun. 30, 2022. The entire content of the priority application is incorporated herein by reference.

### BACKGROUND ART

A liquid discharging apparatus configured to perform a desired printing process to a printing medium by discharging an ink to the printing medium is conventionally known. In the conventional liquid discharging apparatus, a technique in which an ink not used in the printing process is collected, as a waste liquid, to a waste liquid reservoir has been put to practical use.

For example, regarding a liquid discharging apparatus having a housing configured such that the front-surface-side-area of the housing is opened based on a rotation of a cover performed by a user, it is proposed to arrange the waste liquid reservoir at the front-surface-side-area of the housing and above an ejecting (discharging) part for ejecting (discharging) the printing medium to which the printing process has been performed.

### DESCRIPTION

In the conventional liquid discharging apparatus, the waste liquid reservoir is arranged in the front-surface-side-area of the housing being the front-side-area of the product. Thus, there is a fear that a hand etc. of the user unintentionally makes contact with the waste liquid reservoir, a tube configured to flow the waste liquid to the waste liquid reservoir, or a joint between the waste liquid reservoir and the tube, etc., in a case that the front-surface-side-area of the housing is opened by the user. Therefore, in the conventional liquid discharging apparatus, a problem that the hand etc. of the user is gotten dirty by the waste liquid leaked from the waste liquid reservoir etc. has been sometimes occurred.

An object of the present disclosure is to provide a liquid discharging apparatus capable of suppressing occurrence of getting dirty of a hand(s) of a user etc. caused by a waste liquid.

According to an aspect of the present disclosure, there is provided a liquid discharging apparatus including: a housing; a head including a nozzle configured to discharge a liquid to a printing medium; a waste liquid reservoir configured to store a waste liquid of the liquid, the waste liquid reservoir being configured to be inserted into and drawn from the housing; and a conveying route via which the printing medium is to be conveyed in a conveying direction. In a state that the waste liquid reservoir is inserted in the housing, the waste liquid reservoir is arranged in an inside of the housing, and at a position upstream of the head in the conveying direction and above the conveying route.

According an aspect of the present disclosure, it is possible to provide a liquid discharging apparatus capable of suppressing occurrence of getting dirty of a hand(s) of a user etc. caused by a waste liquid.

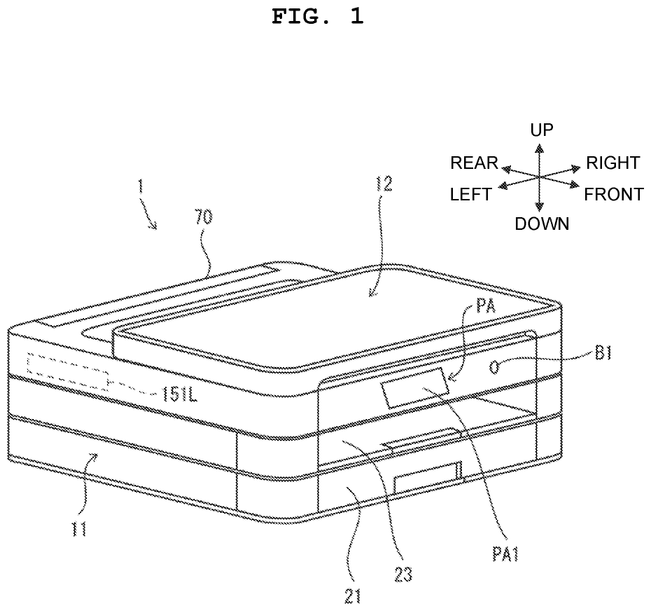

FIG. 1 is an outside perspective view of an ink-jet printer.

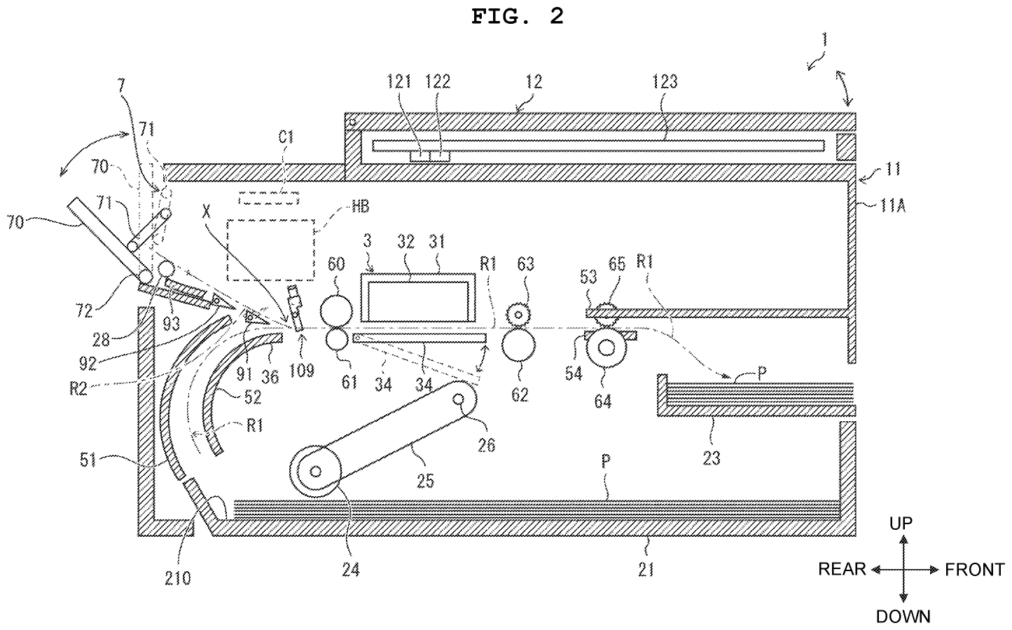

FIG. 2 is a cross-sectional view depicting a schema of an internal configuration of the ink-jet printer.

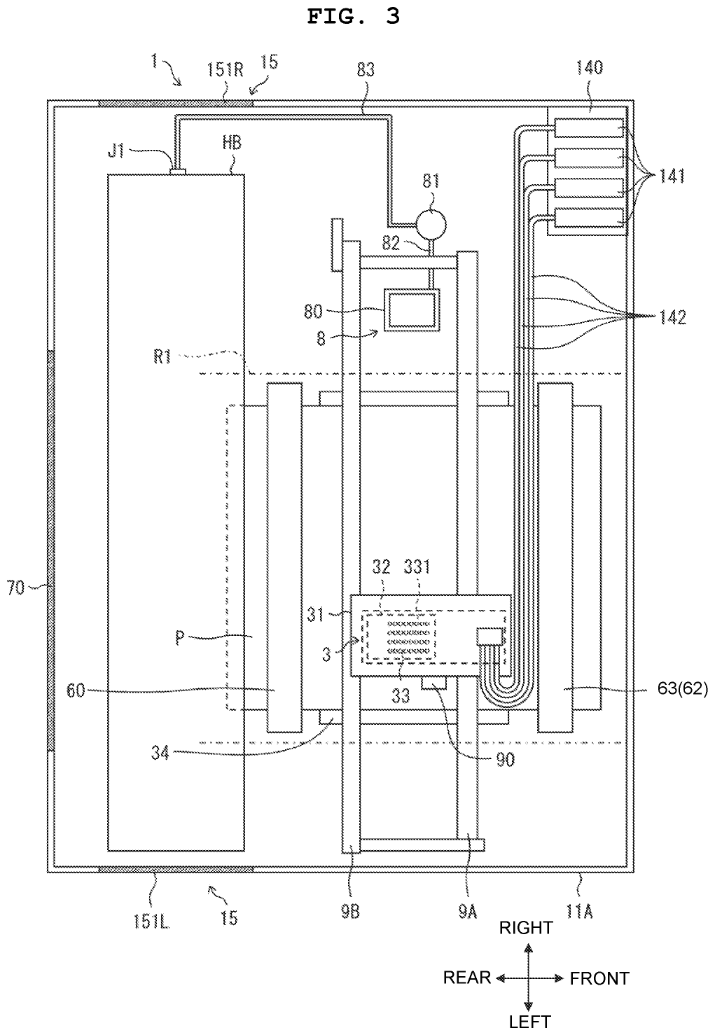

FIG. 3 is a plain view depicting a configuration of the ink-jet printer.

FIG. 4 is a view illustrating a relationship between the waste liquid box depicted in FIG. 2 and a control board.

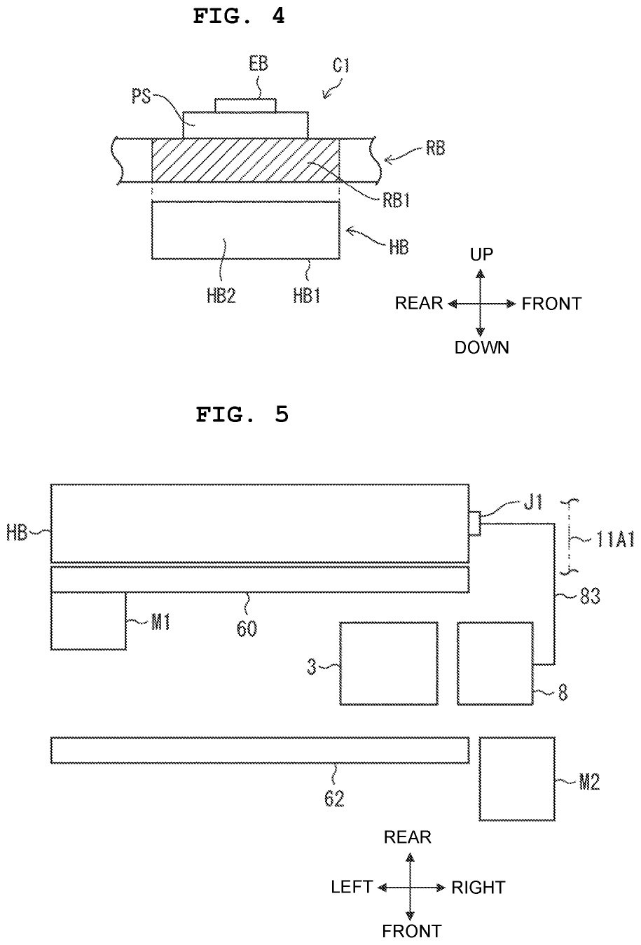

FIG. 5 is a view illustrating an arrangement example of the waste liquid box.

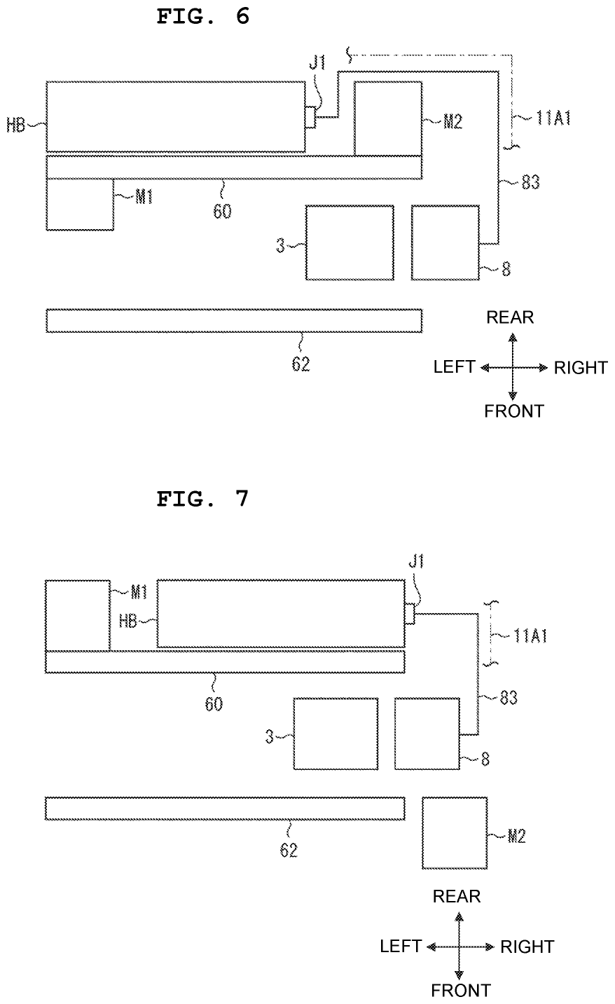

FIG. 6 is a view illustrating an arrangement example of a waste liquid box of an ink-jet printer.

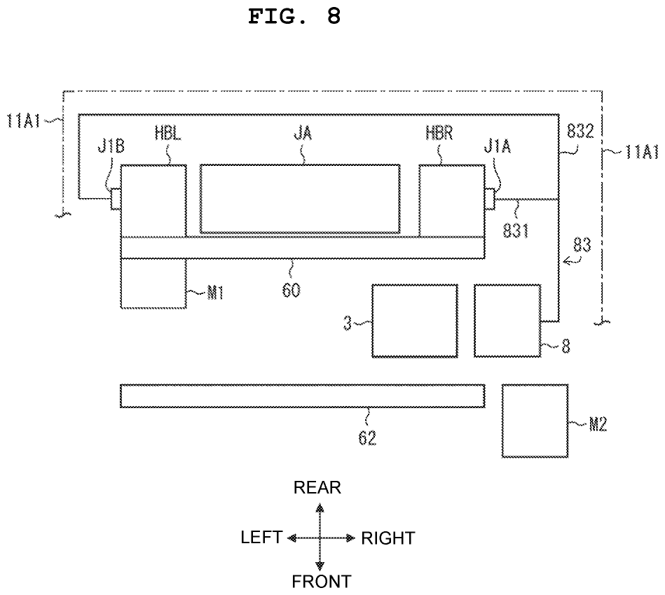

FIG. 7 is a view illustrating an arrangement example of a waste liquid box of an ink-jet printer.

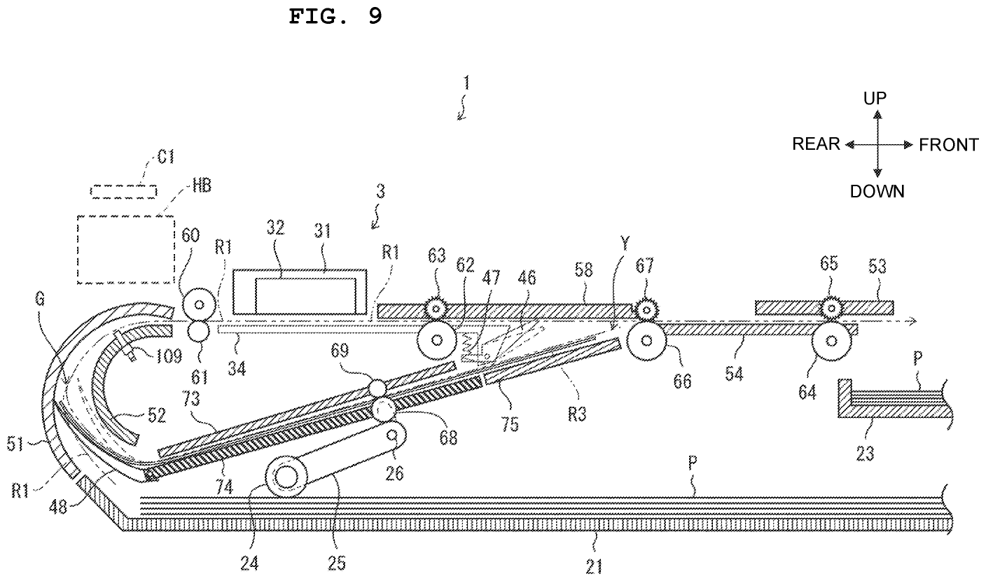

FIG. 8 is a view illustrating an arrangement example of a waste liquid box of an ink-jet printer.

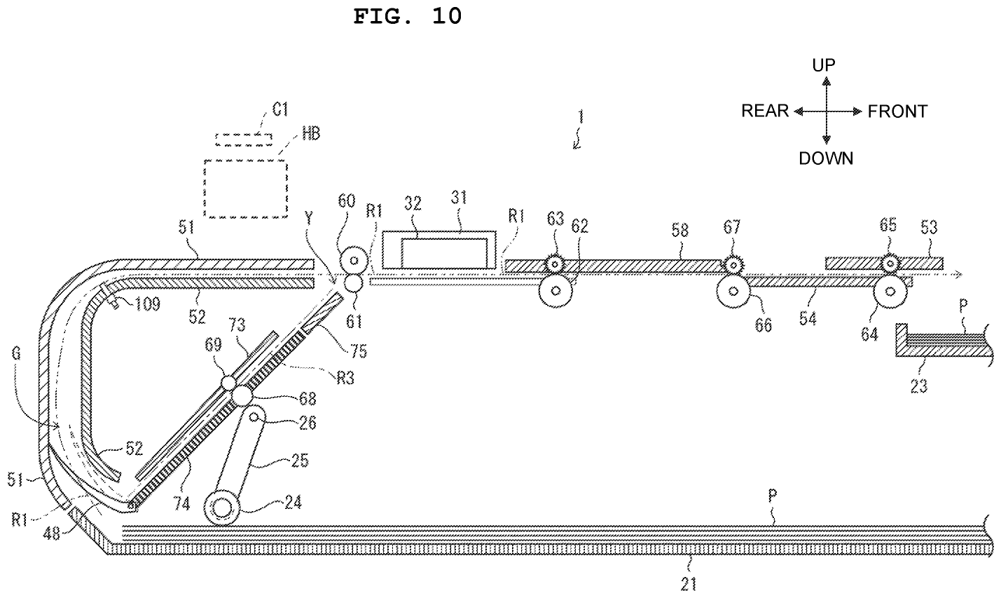

FIG. 9 is a cross-sectional view depicting a schema of an internal configuration of an ink-jet printer.

FIG. 10 is a cross-sectional view depicting a schema of an internal configuration of an ink-jet printer.

### FIRST EMBODIMENT

(Schema of Configuration of Ink-Jet Printer 1)

In the following, the first embodiment of the present disclosure will be described with reference to FIG. 1 to FIG. 3. FIG. 1 is the outside perspective view of the ink-jet printer 1 according the first embodiment. FIG. 2 is the cross-sectional view depicting the schema of the internal configuration of the ink-jet printer 1. FIG. 3 is the plain view depicting the configuration of the ink-jet printer 1. Note that, in the following description, the ink-jet printer 1 is exemplified by a color printer configured to perform a printing process for a full-colored image. However, the present embodiment is not limited thereto. For example, the ink-jet printer 1 may be a mono-chrome printer configured to perform a printing process for a monochrome image.

In FIG. 1, the ink-jet printer 1 is an example a liquid discharging apparatus. In the following description, an up-down direction is defined based on a reference state in which the ink-jet printer 1 is installed operably as depicted in FIG. 1. A side at which the installation surface is positioned is defined as down-side. A front-rear direction is defined such that a side at which an opening to an ejecting (discharging) tray 23 is arranged is defined as a front-side. A left-right direction is defined such that the left-side of the ink-jet printer 1 as seen from the front-side is defined as a left-side. Note that, the left-right direction will also be referred to as a scanning direction being a moving direction of a carriage 31 (FIG. 2) described below. The front-rear direction is a direction same as a conveying direction for a sheet P (FIG. 2) being a printing medium.

As depicted in FIG. 1, the ink-jet printer 1 has a printing function being an image forming function by an ink as a liquid. The ink-jet printer 1 includes an image forming unit 11 housed in a housing 11A (FIG. 2) having a substantially cuboid shape. Further, the ink-jet printer 1 includes an image reading unit (reader) 12 which is provided above the image forming unit 11 and which has a scanning function. As such, the ink-jet printer 1 is a MFP (Multifunction Printer) having a plurality of functions. Note that, other than the functions described here, the ink-jet printer 1 may include function(s) such as a copying function, a facsimile function, etc.

In the front-surface of the image forming unit 11, a display part PA and a power button B1 are provided, for example. Various operation buttons (not depicted) are arranged adjacent to the display part PA and the power button B1. An undepicted cartridge cover is provided in the front-surface of the image forming unit 11 such that the cartridge cover can be opened and closed with respect to the housing 11A (FIG. 3). As depicted in FIG. 3, ink cartridges 141 installed in a cartridge case 140 are arranged inside the housing 11A at a position behind the cartridge cover. The housing 11A is a box having an opening part formed at upper-side-area of the housing 11A. The housing 11A includes a main body in which components of the image forming unit 11 is housed and a cover configured to open and close the opening part of the housing 11A. In the housing 11A, in a case that the cover is opened by a user, the front-surface-side-area of the main body of the housing 11A is opened and the upper-side-part of the components of the image forming unit 11 is exposed.

In FIG. 1, the display part PA includes a display panel PA1 such as a liquid crystal panel etc., and is configured to display a predetermined information following an instruction from an undepicted controller. As depicted in FIG. 1, the display panel PA1 is arranged in the front-surface-side-area of the housing 11A in the front-rear direction. The display part PA may be configured to accept instructions from the user, by installing a touch panel in the display panel PA1.

In the ink-jet printer 1 of the first embodiment, a feeding tray 21 and an ejecting (discharging) tray 23 are arranged at an opening formed in the front-surface of the image forming unit 11, such that each of the feeding tray 21 and the ejecting tray 23 can be moved in the front-rear direction. That is, each of the feeding tray 21 and the ejecting tray 23 is provided in the housing 11A such that each of the feeding tray 21 and the ejecting tray 23 is detachable from the housing 11A. The sheet P (FIG. 2) is accommodated in the feeding tray 21. The sheet P after the image forming process (printing process) is accommodated in the ejecting tray 23. Note that, the sheet P is not limited to a paper medium such as a printing paper (paper sheet) etc., and may be a resin medium made of plastic, such as for example an OHP sheet, etc.

In the ink-jet printer 1 according to the first embodiment, a lid part 151L is provided in the left-side-surface of the housing 11A. The ink-jet printer 1 is configured such that a waste liquid box HB (FIG. 3) is capable of being replaced via the lid part 151L. The ink-jet printer 1 according to the first embodiment is also configured such that the waste liquid box HB is capable of being replaced via the right-side-surface of the housing 11A.

(Internal Configuration of Ink-Jet Printer 1)

Internal configuration of the ink-jet printer 1 of the first embodiment will be described with reference to FIG. 2 and FIG. 3.

As depicted in FIG. 2, in the ink-jet printer 1 of the first embodiment, the image forming unit 11 includes a first feeding roller 24, a first conveying route R1, a first conveying roller 60, and a recording unit 3. The image forming unit 11 further includes a second conveying roller 62, an ejecting (discharging) roller 64, a second feeding roller 28, a first flap 91 and a second flap 92.

The first feeding roller 24 is a roller for feeding the sheet P accommodated in the feeding tray 21 to the first conveying route R1. The first feeding roller 24 is rotatably supported by the feeding arm 25 at the tip of the feeding arm 25. The feeding arm 25 is rotatably supported by a shaft 26 supported by a frame of the ink-jet printer 1. The feeding arm is biased toward the feeding tray 21 in a rotation direction by the weight of the feeding arm itself, an elastic force by a spring etc. Note that the feeding tray 21 has a placement surface 210, and accommodates a plurality of sheets P in a state that the plurality of sheets P is sequentially piled on the placement surface 210.

The first feeding roller 24 rotates positively based on driving of undepicted feeding motor. By the first feeding roller 24 rotating positively, the sheets P accommodated in the feeding tray 21 is taken out to the first conveying route R1 one by one. Then, the sheet P is conveyed in a conveying direction, that is a direction extending from the rear-side of the image forming unit 11 to the front-side of the image forming unit 11, along the first conveying route R1.

The first conveying route R1 is formed or defined by guide members 51, 52, 53 and 54, and the recording unit 3 etc. The first conveying route R1 is a route extends upwardly from the rear end part of the feeding tray 21; curved in an area defined by the guide members 51, 52; extends linearly in an area defined by the guide members 53, 54 via the position at which the recording unit 3 is provided; and reaches the ejecting tray 23. The first conveying route R1 is an example of a conveying route via which the sheet P is to be conveyed.

The first conveying roller 60 is arranged, in the first conveying route R1, upstream of the recording unit 3 in the conveying direction. A pinch roller 61 is arranged at a position facing the lower part of the first conveying roller 60. The first conveying roller 60 is driven by the conveying motor M1 (FIG. 5). The pinch roller 61 rotates following the rotation of the first conveying roller 60. By the positive rotation of the first conveying roller 60 and the pinch roller 61, the sheet P is conveyed to the recording unit 3 in a state that the sheet P is pinched by the first conveying roller 60 and the pinch roller 61.

The recording unit 3 is arranged, in the first conveying route R1, between the first conveying roller 60 and the second conveying roller 62. The recording unit 3 is configured to record an image on the sheet P. The recording unit 3 includes a carriage 31, a recording head 32 being an example of the liquid discharging head (head), a plurality of nozzles 33, and a platen 34. The carriage 31 is supported by a guide rail 9A and a guide rail 9B each extending in the left-right direction. The carriage 31 moves back and forth in the scanning direction, that is a widthwise direction (the left-right direction) of the sheet P being conveyed, by driving force transmitted from a carriage motor M2 (FIG. 5).

The recording head 32 is mounted on the carriage 31. The plurality of nozzles 33 is provided in the lower-surface of the recording head 32. The plurality of nozzles 33 is arranged in the front-rear direction to form a nozzle row. Four nozzle rows arranged in the left-right direction are formed in a nozzle surface 331. As an example, a black (K) ink is discharged from the plurality of nozzles 33 constructing the rightmost nozzle row. A yellow (Y) ink is discharged from the plurality of nozzles 33 constructing the second nozzle row from the right. A cyan (C) ink is discharged from the plurality of nozzles 33 constructing the third nozzle row from the right. A magenta (M) ink is discharged from the plurality of nozzles 33 constructing the leftmost nozzle row. Note that an arrangement order of the nozzle rows is not limited thereto, and may be changed product by product.

The recording head 32 is configured to discharge ink droplets from nozzles 33 by oscillating oscillation elements such as undepicted piezoelectric elements in accordance with instructions from undepicted controller.

The platen 34 is positioned below the recording head 32, and extends over the total length in the left-right direction of the sheet P. During the recording process, the platen 34 supports the sheet P from a position below the sheet P. An image is recorded on the sheet P, by the recording head 32 selectively discharging the ink droplets to the sheet P supported by the platen 34, in a process in which the carriage 31 is moved.

The platen 34 is arranged such that the platen 34 can rotate between a first position at which the platen 34 is in parallel with the first conveying route R and a second position at which the platen is rotated downwardly from the first position as much as a predetermined angle. During the conveying of the sheet P and the printing to the sheet P, the platen 34 is positioned at the first position. On the other hand, in a case that a jam of the sheet P etc. is occurred, the user moves the platen 34 to the second position to bring a state in which the recording unit 3 and an opening part 7 provided at rear part of the ink-jet printer 1 are communicated with each other. With this, it is possible for the user to perform the process for removing the jammed sheet P.

In the ink-jet printer 1 of the first embodiment, in the printing to the sheet P, the controller causes the nozzles 33 of the recording head 32 to discharge ink droplets while moving the carriage 31 in the scanning direction, in a state that the conveying of the sheet P is stopped. Then, the controller repeats a recording process of recording an image corresponding to one line to the sheet P and a conveying process of conveying the sheet P as much as a predetermined line feed amount by driving the first conveying roller 60 and the second conveying roller 62.

The second conveying roller 62 is arranged, in the first conveying route R1, downstream of the recording unit 3 in the conveying direction. A spur roller 63 is arranged at a position facing the upper part of the second conveying roller 62. The second conveying roller 62 is driven by the conveying motor M1 (FIG. 5). The spur roller 63 is rotated following the rotation of the second conveying roller 62. By the positive rotation of the second conveying roller 62 and the spur roller 63, the sheet P is conveyed to the ejecting tray 23-side in a state that the sheet P is pinched between the second conveying roller 62 and the spur roller 63.

The ejecting roller 64 is arranged at a position, in the first conveying route R1, downstream of the second conveying roller 62 in the conveying direction. The spur roller 65 is arranged at a position facing the upper part of the ejecting roller 64. The ejecting roller 64 is driven by the conveying motor M1 (FIG. 5). The spur roller 65 is rotated following the rotation of the ejecting roller 64. By the positive rotation of the ejecting roller 64 and the spur roller 65, the sheet P is ejected to the ejecting tray 23 in a state that the sheet P is pinched between the ejecting roller 64 and the spur roller 65.

The opening part 7 is formed in the rear-surface of the image forming unit 11. A back-surface accommodating unit 70 is arranged at the opening part 7 such that the back-surface accommodating unit 70 is capable of opening and closing the opening part 7. That is, the back-surface accommodating unit 70 as a back-surface feeding unit (feeder) configured to feed the sheet P to the first conveying route R1 is provided at the rear-surface-side-area of the housing 11A. The back-surface accommodating unit 70 is capable of accommodating the sheets P of various sizes. The back-surface accommodating unit 70 displaces, with respect to the image forming unit 11, between a close state at which the back-surface accommodating unit 70 covers the opening part 7 (see, dotted line in FIG. 2) and an open state at which the back-surface accommodating unit 70 does not cover the opening part 7 (see, a solid line in FIG. 2), by rotating about a rotation axis (shaft) 72 as indicated by an arrow depicted in FIG. 2. That is, the ink-jet printer 1 of the first embodiment is configured such that the user can supply a desired sheet P to the recording unit 3 by his/her hand via the back-surface accommodating unit 70.

A guide member 71 to guide the sheet P to the back surface accommodating unit 70 is provided in the back-surface accommodating unit 70. The guide member 71 is configured to guide the sheet P to the back-surface accommodating unit 70 by rotating interlocked (linked) with the back-surface accommodating unit 70 while making contact with the sheet P. The second feeding roller 28 is provided in the back-surface accommodating unit 70. The second feeding roller 28 is a roller configured to feed the sheet P accommodated in the back-surface accommodating unit 70 to the first conveying route R1 via the second conveying route R2.

Specifically, in the second conveying route R2, the sheet P fed by the second feeding roller 28 is sequentially guided by the guide member 93, the first flap 91, and the second flap 92, and is fed to the first conveying route R1 at a merging point X. The first flap 91 is biased downwardly by a coil spring (not depicted), and is arranged such that the first flap 91 is rotatable between a first state depicted in FIG. 2 by the dotted line and a second state depicted in FIG. 2 by the solid line. The first flap 91 in the first state constitutes a portion of the first conveying route R1, and the first flap 91 in the second state constitutes a portion of the second conveying route R2. The second flap 92 constitutes a portion of the second conveying route R2. The tip of the second flap 92 is configured such that the position of the tip is capable of being adjusted by driving of an undepicted motor.

A register sensor 109 is provided at a position, in the first conveying route R1, upstream of the first conveying roller 60. The register sensor 109 is a sensor configured to detect a situation in which the front end or the rear end of the sheet P passes an abutting position at which the sheet P abuts (makes contact with) the first conveying roller 60. A sensor having an actuator configured to swing based on abutment with the sheet P, a photo sensor, and the like may be used as the register sensor 109. In a state that the sheet P is moving through a position where the sheet P abuts the first conveying roller 60, the register senser 109 outputs ON signal. In a state that the sheet P is not moving through the position where the sheet P abuts the first conveying roller 60, the register senser 109 outputs OFF signal. A detecting signal from the register sensor 109 is outputted to undepicted controller.

A rotary encoder (not depicted) is provided on the first conveying roller 60. A rotation amount of the first conveying roller 60 is detected by the rotary encoder, and a detecting signal is outputted to the controller. The controller estimates a conveying amount in the first conveying route R1 of the sheet P by using the detecting signal from the register sensor 109 and the detecting signal from the rotary encoder.

As depicted in FIG. 2, the image reading unit 12 includes a light source 121, a light receiving part 122, and a glass plate 123. The light source 121 is configured by a light emitting diode etc., and is configured to irradiate the sheet P, manuscript, etc. placed on the glass plate 123 made of a transparent plate member with a light. The light receiving part 122 includes a plurality of light receiving elements. A white referential plate (not depicted) is arranged at a position facing the light receiving part 122. The light receiving part 122 receives the light emitted from the light source 121 to the sheet P, the manuscript, etc., and reflected by the white referential plate. The scanning function is performed by the light receiving part 122 outputting the detecting result of the receiving light to the controller. The image reading unit 122 is an example of a reader configured to read an object as an image.

As depicted in FIG. 3, in the ink-jet printer 1 of the first embodiment, a cartridge case 140 is provided at the inside of the housing 11A. The cartridge case 140 includes four ink cartridges 141 arranged in the left-right direction. Each of the ink cartridges 141 is provided such that each of the ink cartridges 141 can be replaced with respect to the cartridge case 140 by opening a cartridge cover (not depicted). The four ink cartridges 141 contains the black ink, the yellow ink, the cyan ink and the magenta ink, respectively. The ink contained in each of the ink cartridges 141 is supplied to the recording head 32 via the tube 142.

The ink-jet printer 1 of the first embodiment includes a maintenance unit 8. The maintenance unit 8 includes a cap 80, a pump 81, and tubes 82, 83. The maintenance unit 8 is arranged at a position below a scanning route of the carriage 31 and outside in the scanning direction of the platen 34. In the first embodiment, the maintenance unit 8 is positioned in right of the platen 34 in the left-right direction. Note that the position at which the maintenance unit 8 is arranged is not limited to right of the platen 34. The maintenance unit 8 may be arranged in left of the platen 34.

The cap 80 is made of a rubber material. The cap 80 is arranged at a position below the recording head 32 and outside in the scanning direction of the platen 34. In a case that the carriage 31 is moved to a maintenance position outside of the platen 34, the cap 80 and the nozzle surface 331 face with each other.

The cap 80 is configured such that the cap 80 is capable of moving in the up-down direction by a lift mechanism (not depicted). The cap 80 makes contact with the nozzle surface 331 by moving in the up-direction at the maintenance position.

The pump 81 sucks the ink etc. in the nozzle(s) 33 via the cap 80 and the tube 82 by being driven by a motor (not depicted), and drains (discharges) the ink etc. sucked from the nozzle(s) 33 to the waste liquid box HB through the tube 83.

The tube 82 is a channel to transfer the ink drained from the maintenance unit 8 to the pump 81. The tube 83 is connected to the waste liquid box HB via a joint J1 described below so as to connect the pump 81 and the waste liquid box HB. The tubes 82, 83 are configured by a material having flexibility, and is configured to transfer the ink from the cap 80 to the waste liquid box HB via the pump 81.

Based on the configuration described above, the maintenance unit 8 performs maintenance of the recording head 32. More specifically, the maintenance unit 8 executes a parge operation of sucking the ink and/or air in the nozzle 33 and a foreign body adhered to an opening formed at the lower-surface (lower-part) of the nozzle 33. Note that, in the following, the ink and the air in the nozzle 33, and the foreign body adhered to the opening of the nozzle 33 are referred to as “ink etc.”. The ink etc. sucked and removed by the maintenance unit 8 is stored in the waste liquid box HB as a waste liquid.

(Configuration of Waste Liquid Box HB)

The waste liquid box HB will be described concretely with reference to FIG. 4 and FIG. 5. FIG. 4 is a view illustrating a relationship between the waste liquid box HB and the control board C1 depicted in FIG. 2. FIG. 5 is a view illustrating an example of an arrangement of the waste liquid box HB.

As depicted in FIG. 2 to FIG. 5, the ink-jet printer 1 of the first embodiment includes the waste liquid box HB configured to store the ink etc. provided in the inside of the housing 11A. As depicted in FIG. 4, the waste liquid box HB includes a waste liquid case HB1, an ink absorbing foam HB2 and the joint J1. The waste liquid box HB is an example of a waste liquid reservoir.

The waste liquid case HB1 is configured by a synthetic resin material, for example. The waste liquid case HB1 is, for example, a cuboid box. The ink absorbing foam HB2 is provided in the inside of the waste liquid case HB1. The waste liquid case HB1 is an example of a container. The ink absorbing foam HB2 is an example of an absorbing foam.

The ink absorbing foam HB2 is configured by an unwoven fabric, a sponge, or cotton etc. capable of absorbing the ink etc. The ink absorbing foam HB2 is configured by a configuration material of which color is white, for example. The ink absorbing foam HB2 is configured such that the color of the ink absorbing foam HB2 changes gradually from white to black as the ink absorbing foam HB2 absorbs the ink etc. That is, the ink absorbing foam HB2 is configured to change its color to black depending on degree of absorbing amount, by absorbing the black ink itself, or by absorbing an ink having black color made by mixing the yellow ink, the cyan ink and the magenta ink.

The joint J1 is an example a joint. The joint J1 is a part configured to connect the tube 83 to the waste liquid case HB1. The joint J1 is provided at the right-wall in the left-right direction of the waste liquid case HB1. The joint J1 forms a communication hole configured to communicate the inside of the waste liquid case HB1 and the outside of the waste liquid case HB1. The joint J1 is configured such that the tube 83 is capable of being connected to the joint J1. By connecting the maintenance unit 8 and the joint J1 by the tube 83, the ink etc. drained from the maintenance unit 8 is stored in the waste liquid case HB1 of the waste liquid box HB

Note that, a position in the waste liquid box HB at which the joint J1 is provided is not limited to the right-wall in the left-right direction of the waste liquid case HB1. The joint J1 may be provided at any position where the waste liquid box HB and the maintenance unit 8 can be connected via the joint J1.

As depicted in FIG. 2 and FIG. 3, the waste liquid box HB is arranged in the inside of the housing 11A, upstream of the recording head 32 in the conveying direction for the sheet P, and above the first conveying route R1. As depicted in FIG. 2, at least a portion of the waste liquid box HB is provided at a position where the portion of the waste liquid box HB overlaps with the carriage 31 in the up-down direction orthogonal to the nozzle surface 331 of the recording head 32, as seen in the left-right direction orthogonal to the conveying direction.

Note that, in the above, the configuration in which the waste liquid box HB is provided at the position where the portion of the waste liquid box HB and the carriage 31 are overlapped with each other in the up-down direction is described. However, the present disclosure is not limited thereto. The waste liquid box HB may be provided such that at least a portion of the waste liquid box HB is positioned to overlap with the recording head 32 mounted below the carriage 31 (see, FIG. 9). By such configuration, it is possible to arranged the waste liquid box HB in the inside of the housing 11A while suppressing the housing 11A from being made large in the up-down direction. Thus, it is possible to easily configure a compact ink-jet printer 1.

Here, wording of “a first part overlaps with a second part in the up-down direction” means, for example, a situation in which the first part and the second part are arranged at the same position in the up-down direction (that is, the same height position). For example, in FIG. 2, in a case that the housing 11A is seen from the front, at least a portion of the waste liquid box HB and the recording head 32 are arranged at the same position in the up-down direction. That is, as depicted in FIG. 2, in a case that the housing 11A is seen from right or left, at least a portion of the waste liquid box HB and the recording head 32 are arranged at the same position in the up-down direction. Thus, the at least the portion of the waste liquid box HB overlap with the recording head 32 in the up-down direction.

The waste box HB is configured such that the waste liquid box HB is capable of being inserted into and drawing from the housing 11A. Specifically, as depicted in FIG. 3, a box replacing part 15 is provided at the left-side-surface and the right-side-surface of the housing 11A. The box replacing parts 15 includes lid parts 151L and 151R each capable of rotating with respect to the housing 11A. That is, each of the box replacing parts 15 is configured such that inserting and drawing of the waste liquid box HB with respect to the housing 11A is allowed by opening and closing the lid part 151L or the lid part 151R.

Other than the configuration described above, it is possible to adopt the configuration in which the housing 11A includes one of the lid part 151L and the lid part 151R.

The box replacing part 15 is not limited to the configuration in which the lid part 151L or the lid part 151R are opened and closed. For example, a configuration in which a waste liquid box unit capable of detaching from the casing 11A is inserted into and drawing from the housing 11A may be used. The waste liquid box unit includes the waste liquid box HB and a box holder, for the waste liquid box HB, having the lid part 151L or the lid part 151R. In this configuration, in a case that the waste liquid box unit is drawn from the housing 11A, an opening having a shape corresponding to the shape of the waste liquid box unit is exposed at the box replacing part 15. In a case that the waste liquid box unit is inserted into the exposed opening, the exposed opening is covered by the lid part 151L or 151R of the waste liquid box unit.

Note that the position at which the box replacing part 15 is provided is not limited to the side-surface in the left-right direction of the housing 11A. For example, the box replacing part 15 may be provided at the rear-surface in the front-rear direction of the housing 11A.

As depicted in FIG. 2 and FIG. 4, the waste liquid box HB is arranged at a position below the control board C1. The control board C1 includes an electronic parts EB, and a print circuit board PS on which the electronic parts EB are mounted. The electronic parts EB may include a CPU (Central Processing Unit), a ROM (Read Only Memory), a RAM (Random Access Memory), an EEPROM (trade mark), and an ASIC (Application Specification Integrated Circuit), etc. constituting the controller. The print circuit board PS is attached to the supporting part RB configured to support the circuit board C1. The supporting part RB includes a shielding part RB1 configured to shield the waste liquid box HB. The supporting part RB is configured by using a synthetic resin, for example. The supporting part RB is a structural member, such as a rib, a frame, etc., provided at the inside of the housing 11A.

As depicted in FIG. 2, the waste liquid box HB is provided at a position below the image reading unit 12 in the up-down direction. As depicted in FIG. 3, in the front-rear direction, the waste liquid box HB is arranged at a position upstream of the guide rails 9A and 9B in the conveying direction, and is arranged at a position downstream of the back-surface accommodating unit 70 in the conveying direction.

As depicted in FIG. 5, the waste liquid box HB is connected to the maintenance unit 8 via the joint J1 at one of the right-side-area and the left-side-area of the housing 11A in the left-right direction parallel with the nozzle surface 331 of the recording head 32 of the recording unit 3 and orthogonal to the conveying direction, the one of the right-side-area and the left-side-area of the housing 11A being same as one of the right-side-area and the left-side-area of the housing 11A in which the maintenance unit 8 is arranged. The tube 83 is provided along the side-surface 11A1 of the main body (body) the housing 11A. Thus, in the ink-jet printer 1 of the first embodiment, the length of the tube 83 can be made small. Note that, the side-surface 11A1 of the main body constitute the main body of the housing 11A. The side-surface 11A1 is, for example, resin base side-surface made of a synthetic resin. The resin base includes a rib etc. as resin base parts.

In the ink-jet printer 1 of the first embodiment, as exemplified in FIG. 5, the conveying motor M1 is provided at a position downstream of the waste liquid box HB in the conveying direction and below the first conveying roller 60. Further, in the ink-jet printer 1 of the first embodiment, as exemplified in FIG. 5, the carriage motor M2 is provided at a position downstream of the waste liquid box HB in the conveying direction and in right of the second conveying roller 62.

Based on the above configuration, the ink-jet printer 1 cause the ink to be discharged while moving the recording head 32 in the scanning direction together with the carriage 31, and while conveying the sheet P in the conveying direction by the first conveying roller 60 and the second conveying roller 62 etc. With this, the ink-jet printer 1 prints an image on the sheet P.

As described above, the ink-jet printer 1 of the first embodiment includes the housing 11A, and the recording head 32 having the nozzles 33 configured to discharge the ink to the sheet P. The ink-jet printer 1 includes the waste liquid box HB which is configured to store the waste liquid of the ink and which is configured to be inserted into and drawn from the housing 11A, and the first conveying route R1 via which the sheet P is to be conveyed. In the ink-jet printer 1, the waste liquid box HB is arranged in the inside of the housing 11A, upstream of the recording head 32 in the conveying direction for the sheet P, and above the first conveying route R1.

Based on the above configuration, in the ink-jet printer 1 of the first embodiment, the waste liquid box HB is arranged in the inside of the housing 11A, and at the upper-back-surface-side-area of the housing 11A. Thus, in the ink-jet printer 1 of the first embodiment, as depicted in FIG. 2, the waste liquid box HB can be arranged in an open space (free space) in the housing 11A while utilizing the open space efficiently. Further, in the ink-jet printer 1 of the first embodiment, it is possible to easily suppress occurrence of unintentional contact between the user and the waste liquid box HB etc., because the waste liquid box HB is arranged in the area of the housing 11A to which the user does not make access frequently. Thus, it is possible to configured the ink-jet printer 1 capable of suppressing getting dirty of the hand(s) of the user etc. caused by the waste liquid. Further, in the first embodiment, it is possible to reduce possibility of scattering of the waste liquid to the outside of the housing 11A, because occurrence of the contact between the user and the waste liquid box HB etc. is suppressed. Thus, it is also possible to easily suppress occurrence of getting dirty of the hand(s) of the user etc. caused by the waste liquid attached to the outer-surface of the housing 11A.

In the ink-jet printer 1 of the first embodiment, the waste liquid box HB is efficiently arranged in the free space in the housing 11A. Thus, even if the waste liquid box HB is made larger, it is possible to arranged the waste liquid box HB in the housing 11A easily. Therefore, in the ink-jet printer 1 of the first embodiment, it is possible to provide the waste liquid box HB of which replacement frequency is small, and to easily constitute the ink-jet printer 1 capable of simplifying an operation for replacing the waste liquid box HB.

As depicted in FIG. 2 or FIG. 3, in the ink-jet printer 1 of the first embodiment, the waste liquid box HB is arranged at a position where the waste liquid box HB does not overlap with the recording head 32 as seen from the up-side of the housing 11A. Thus, in the ink-jet printer 1 of the first embodiment, it is possible to reduce the height of the ink-jet printer 1 by, for example, arranging the waste liquid box HB and the recording head 32 overlapped with each other in the up-down direction. Further, the waste liquid box HB is arranged at a position where the waste liquid box HB overlaps with the first conveying route R1 as seen from the up-side of the housing 11A, dimensions in the front-rear direction and the left-right direction of the housing 11A can be reduced, and consequently dimensions in the front-rear direction and the left-right direction of the ink-jet printer 1 can be reduced. As a result, in the first embodiment, the ink-jet printer 1 can be downsized easily.

In the ink-jet printer 1 of the first embodiment, predetermined electric parts including the display panel PA1, the power button B1 etc. are provided at the front-surface-side of the housing 11A. Thus, in the housing 11A, those electric parts are arranged apart from waste liquid box HB. With this, it is possible to greatly reduce the possibility of scattering of the waste liquid from the waste liquid box HB etc. to those electric parts. Therefore, in the ink-jet printer of the first embodiment, it is possible to easily suppress occurrence of trouble (failure) etc. of those electric parts caused due to the waste liquid.

As depicted in FIG. 2, in the ink-jet printer 1 of the first embodiment, the waste liquid box HB is arranged below the image reading unit 12. Thus, even if the ink-jet printer 1 capable of executing the scanning function is downsized, it is possible to suppress occurrence of getting dirty of the hand(s) of the user etc. caused by the waste liquid. Further, in the first embodiment, the waste liquid box HB is arranged below the image reading unit 12 having relatively large area (size) as seen from the up-side of the housing 11A. Thus, it is possible to reduce the height of the ink-jet printer 1 easily.

As depicted in FIG. 3, in the ink-jet printer 1 of the first embodiment, the waste liquid box HB is arranged at a position upstream of the guide rails 9A and 9B in the conveying direction. Thus, the waste liquid box HB is arranged in the open space defined between the carriage 31 and the back-surface of the housing 11A (that is, in one side of the carriage 31 close to the back-surface of the housing 11A). As a result, in the first embodiment, the ink-jet printer 1 can be downsized easily. Further, in the first embodiment, the waste liquid box HB is arranged at a position where the waste liquid box HB does not overlap with the guide rails 9A and 9B as seen from the up-side of the housing 11A. Thus, it is possible to reduce the height of the ink-jet printer 1 easily.

As depicted in FIG. 2 or FIG. 3, in the ink-jet printer 1 of the first embodiment, the waste liquid box HB is arranged at a position downstream of the back-surface accommodating unit 70 in the conveying direction. Thus, in the ink-jet printer 1 of the first embodiment, the waste liquid box HB is arranged in the inside of the housing 11A and in the open space defined in front of the back-surface accommodating unit 70 (that is, in one side of the back-surface accommodating unit 70 close to the front-surface of the housing 11A). As a result, in the first embodiment, the ink-jet printer 1 can be downsized easily. Further, in the first embodiment, the waste liquid box HB is arranged at a position where the waste liquid box HB overlaps with a portion of the second conveying route R2 as seen from the up-side of the housing 11A. Therefore, it is possible to reduce a dimension in the front-rear direction of the ink-jet printer 1 easily.

In the first embodiment, the tube 83 is provided along the side-surface 11A1 of the main body of the housing 11A. Thus, it is possible to downsize the ink jet printer 1 more easily. Further, in the first embodiment, the components of the ink-jet printer 1 can be efficiently arranged at the central part of the housing 11A by arranging the tube 83 along the side-surface 11A1 of the main body of the housing 11A. Thus, the ink-jet printer 1 can be downsized easily.

As depicted in FIG. 4, in the ink-jet printer 1 of the first embodiment, the waste liquid box HB is arranged at a position below the control board C1. Thus, it is possible to suppress occurrence of adhesion of the waste liquid leaked out from the waste liquid box HB to the control board C1. Thus, in the ink-jet printer 1 of the first embodiment, it is possible to suppress occurrence of abnormal such as trouble (failure) in the control board C1. Further, in the first embodiment, the waste liquid box HB is arranged in the open space below the control board C1. Thus, the ink-jet printer 1 can be downsized easily.

As depicted in FIG. 4, the ink-jet printer 1 of the first embodiment includes the supporting part RB which is provided between the waste liquid box HB and the control board Cl, which has the shielding part RB1 configured to shield the waste liquid box HB, and which supports the control board C1. With this, in the ink-jet printer 1 of the first embodiment, it is possible to reliably suppress the scattering of the waste liquid from the waste liquid box HB to the control board C1-side, and thus it is possible to more reliably suppress occurrence of abnormal such as trouble (failure) in the control board C1.

As depicted in FIG. 3, in the ink-jet printer 1 of the first embodiment, the lid part 151L and the lid part 151R each configured to be opened and closed in order to insert and drawn the waste liquid box HB with respect to the housing 11A are provided at the left-side-surface and the right-side-surface of the housing 11A, respectively. With this, in the ink-jet printer 1 of the first embodiment, the waste liquid box HB can be inserted and drawn with respect to the housing 11A by opening the lid part 151L or the lid part 151R. As a result, in the ink-jet printer 1 of the first embodiment, it is possible to replace the waste liquid box HB easily, and simplify the maintenance operation.

In the ink-jet printer 1 of the first embodiment, the waste liquid box HB can be replaced via the left-side-surface or the right-side-surface of the housing 11A. Thus, in the first embodiment, it is possible to replace the waste liquid box HB easily without being interrupted by the image reading unit 12, as compared with a first comparative example having a configuration in which a lid part for replacing the waste liquid box HB is arranged at the upper-surface of the housing 11A. Further, in the ink-jet printer 1 of the first embodiment, it is possible to greatly reduce possibility of scattering of the waste liquid to the front-surface-side of the housing 11A, and thus it is possible to reliably suppress occurrence of trouble etc. of the electric parts arranged in the front-surface-side-area of the housing 11A caused due to the waste liquid. Further, in the first embodiment, it is possible to replace the waste liquid box HB easily without being interrupted by the back-surface accommodating unit 70 as compared with a second comparative example having a structure in which a lid pert for replacing the waste liquid box HB is provided at the back-surface of the housing 11A.

### First Modified Example

In the following, the first modified example of the present disclosure will be described. Note that, for the convenience of the description, members having same functions as the members described relative to the first embodiment will be indicated by the referential numerals same as those of the members described relative to the first embodiment, and description for such members will not be repeated.

FIG. 6 is a view illustrating an example of an arrangement of the waste liquid box HB of the ink-jet printer 1 according to the first modified example of the present disclosure. In FIG. 6, the first modified example is different from the first embodiment mainly in that the waste liquid box HB and the carriage motor M2 are arranged side by side in the left-right direction.

As depicted in FIG. 6, in the ink-jet printer 1 of the first modified example, the waste liquid box HB is arranged in one of the right-side-area and the left-side-area of the housing 11A in the left-right direction parallel with the nozzle surface 331 of the recording head 32 and orthogonal to the conveying direction, and the carriage motor M2 is arranged the other of the right-side-area and the left-side-area of the housing 11A. That is, as depicted in FIG. 6, the waste liquid box HB is arranged in one of the left-side-area and the right-side-area of the housing 11A and the carriage motor M2 is arranged in the other (that is, remaining one) of the left-side-area and the right-side-area of the housing 11A.

Based on the above configuration, the first modified example achieves effects same as or similar to the effects achieved by the first embodiment. Further, in the first modified example, the waste liquid box HB and the carriage motor M2 are arranged oppositely from each other in the left-right direction of the housing 11A. Thus, in the first modified example, the waste liquid box HB is arranged at a position where the waste liquid box HB does not overlap with the carriage motor M2 as seen from the up-side of the housing 11A, and therefore, it is possible to suppress the height of the housing 11A from being made large. With this, in the first modified example, it is possible to configure the small sized ink-jet printer 1 reliably.

### Second Modified Example

In the following, the second modified example of the present disclosure will be described. Note that, for the convenience of the description, members having same functions as the members described relative to the first embodiment will be indicated by the referential numerals same as those of the members described relative to the first embodiment, and description for such members will not be repeated.

FIG. 7 is a view illustrating an example of an arrangement of the waste liquid box HB of the ink-jet printer 1 according to the second modified example of the present disclosure. In FIG. 7, the second modified example is different from the first embodiment mainly in that the waste liquid box HB and the conveying motor M1 are arranged side by side in the left-right direction.

As depicted in FIG. 7, in the ink-jet printer 1 of the first modified example, the waste liquid box HB is arranged in one of the right-side-area and the left-side-area of the housing 11A in the left-right direction parallel with the nozzle surface 331 of the recording head 32 and orthogonal to the conveying direction, and the conveying motor M1 is arranged in the other of the right-side-area and the left-side-area of the housing 11A. That is, as depicted in FIG. 7, the waste liquid box HB is arranged in one of the left-side-area and the right-side-area of the housing 11A and the conveying motor M1 is arranged in the other (that is, remaining one) of the left-side-area and the right-side-area of the housing 11A.

Further, in the ink-jet printer 1 of the second modified example, the waste liquid box HB is arranged, in the left-right direction, in one of the left-side-area and the right-side-area of the housing 11A same as one of the left-side-area and the right-side-area of the housing 11A in which the maintenance unit 8 is arranged. That is, the waste liquid box HB is arranged adjacently to the maintenance unit 8 in the right-side-area of the housing 11A in which the maintenance unit 8 is arranged.

Based on the above configuration, the second modified example achieves effects same as or similar to the effects achieved by the first embodiment. Further, in the second modified example, the waste liquid box HB and the conveying motor M1 are arranged oppositely from each other in the left-right direction of the housing 11A. Thus, in the second modified example, the waste liquid box HB is arranged at a position where the waste liquid box HB does not overlap with the conveying motor M1 as seen from the up-side of the housing 11A, and therefore, it is possible to suppress the height of the housing 11A from being made large. With this, in the second modified example, it is possible to configure the small sized ink-jet printer 1 reliably.

Further, in the second modified example, the waste liquid box HB is arranged adjacently to the maintenance unit 8, and thus the tube 83 can be made short. With this, in the second modified example, it is possible to configure the small sized ink-jet printer 1 reliably.

### Third Modified Example

In the following, the third modified example of the present disclosure will be described. Note that, for the convenience of the description, member having same functions as the members described relative to the first embodiment will be indicated by the referential numerals same as those of the members described relative to the first embodiment, and description for such members will not be repeated.

FIG. 8 is a view illustrating an example of an arrangement of the waste liquid box HB of the ink-jet printer 1 according to the third modified example of the present disclosure. In FIG. 8, the third modified example is different from the first embodiment mainly in that a jam treating mechanism JA and two waste liquid boxes HBR, HBL are arranged side by side in the left-right direction.

As depicted in FIG. 8, the ink-jet printer 1 of the third modified example includes the waste liquid box HBR arranged in the right-side-area of the housing 11A and the waste liquid box HBL arranged in the left-side-area of the housing 11A in the left-right direction in parallel with the nozzle surface 331 of the recording head 32 and orthogonal to the conveying direction. The waste liquid box HBR is connected to the maintenance unit 8 via the tube 831 connected to a joint J1A provided in the right-side-surface of the waste liquid box HBR. The waste liquid box HBL is connected to the maintenance unit 8 via the tube 832 connected to a joint J1B provided in the left-side-surface of the waste liquid box HBL. Each of the tube 831 and the tube 832 is arranged along the side-surface 11A1 of the main body of the housing 11A.

In the ink-jet printer 1 of the third modified example, the jam treating mechanism JA is provided between the waste liquid box HBR and the waste liquid box HBL in the left-right direction. The jam treating mechanism JA is a mechanism which is provided in the first conveying route R1 for resolving a jam of the sheet P (that is, a paper jam) occurred in the first conveying route R1.

Specifically, the jam treating mechanism JA includes a lid member (not depicted) configured to cover the first conveying route R1 from above, at a position upstream of the first conveying roller 60 in the conveying direction. The lid member is configured to be detachable from the housing 11A. The lid member is configured such that, in a case that the jam of the sheet P is occurred in the first conveying route R1, the user detaches the lid member from the housing 11A and removes the sheet P having caused the jam.

Based on the above configuration, the third modified example achieves effects same as or similar to the effects achieved by the first embodiment. Further, in the third modified example, it is possible to suppress the height of the housing 11A from being made large, because the waste liquid box HBR is arranged in right of the jam treating mechanism JA and the waste liquid box HBL is arranged in left of the jam treating mechanism JA. With this, in the third modified example, it is possible to configure the small sized ink-jet printer 1 reliably.

Note that, other than the configuration described above, it is possible to adopt the configuration in which at least one waste liquid box of the waste liquid box HBR and the waste liquid box HBL is arranged side by side with the jam treating mechanism in the left-right direction.

### SECOND EMBODIMENT

In the following, the second embodiment of the present disclosure will be described. Note that, for the convenience of the description, members having same functions as the members described relative to the first embodiment will be indicated by the referential numerals same as those of the members described relative to the first embodiment, and description for such members will not be repeated.

FIG. 9 is a cross-sectional view depicting schema of the internal configuration of the ink-jet printer 1 according to the second embodiment of the present disclosure. In FIG. 9, the second embodiment is different from the first embodiment mainly in that the ink-jet printer 1 is configured such that the ink-jet printer 1 is capable of performing a double-sided printing to the sheet P.

As depicted in FIG. 9, the ink-jet printer 1 of the second embodiment includes a third conveying route R3 for performing the double-sided printing to the sheet P. The third conveying route R3 is an example of a reverse conveying route. The waste liquid box HB is provided above the first conveying route R1 and the third conveying route R3.

A reversing roller 66 is arranged, in the first conveying route R1, at a position downstream of the first conveying roller 60 in the conveying direction. A spur roller 67 is arranged at a position facing the upper part of the reversing roller 66. The reversing roller 66 is driven by the conveying motor M1. The spur roller 67 rotates following the rotation of the reversing roller 66. Based on the positive rotation of the reversing roller 66 and the spur roller 67, the sheet P is conveyed to the ejecting tray 23-side in a state that the sheet P is pinched between the reversing roller 66 and the spur roller 67. On the other hand, based on the inverse rotation of the reversing roller 66 and the spur roller 67, the sheet P is conveyed to the third conveying route R3 in a state that the sheet P is pinched between the reversing roller 66 and the spur roller 67 and guided along the lower-surface of a first flap 46.

The first flap 46 is provided, in the first conveying route R1, at a position between the first conveying roller 60 and the reversing roller 66. The first flap 46 is arranged near a branching position Y facing the guide member 58. The first flap 46 is supported by the platen 34 in a state that the first flap 46 is rotatable between a first state and a second state. In a case that the first flap 46 is in the first state depicted by the solid line in FIG. 9, the first flap 46 is in contact with the guide member 58 so as to close the first conveying route R1. On the other hand, in a case that the first flap 46 is in the second state depicted by the dotted line in FIG. 9, the first flap 46 is positioned below its position in the first state, and separated from the guide member 58 so as to allow the sheet P being conveyed to the ejecting tray 23-side to move through the space between the guide member 58 and the first flap 46.

The first flap 46 is biased upwardly by a coil spring 47. One end of the coil spring 47 is connected to the first flap 46, and the other end of the coil spring 47 is connected to the platen 34. The first flap 46 is brought to the first state by being biased by the coil-spring 47, and the tip of the first flap 46 makes contact with the guide member 58.

A second flap 48 is rotatably arranged at a merging position G of the first conveying route R1 and the third conveying route R3. Specifically, the second flap 48 is rotatable between a first state depicted by the solid line in FIG. 9 and a second state depicted by the dotted line in FIG. 9. In a case that the second flap 48 is in the first state, a portion of the third conveying route R3 is configured by the second flap 48 and the guide member 52. In a case that the second flap 48 is in the second state, a portion of the first conveying route R1 is configured by the second flap 48 and the guide member 51. Note that the register senser 109 is provided on the guide member 52.

The third conveying route R3 is a route defined by the guide members 73, 74, and 75, the third conveying roller 68, and the pinch roller 69 etc. The third conveying route R3 branches from the first conveying route R1 at the branching position Y upstream of the reversing roller 66, and is connected to the first conveying route R1 at the merging position G upstream of the recording unit 3 in the conveying direction.

Based on the above configuration, the second embodiment achieves effects same as or similar to the effects achieved by the first embodiment. Further, in the second embodiment, even if the ink-jet printer 1 capable of performing the double-sided printing is downsized, it is possible to suppress occurrence of getting dirty of the hand(s) of the user etc. caused by the waste liquid.

### Fourth Modified Example

In the following, the fourth modified example of the present disclosure will be described. Note that, for the convenience of the description, members having same functions as the members described relative to the second embodiment will be indicated by the referential numerals same as those of the members described relative to the second embodiment, and description for such members will not be repeated.

FIG. 10 is a cross-sectional view depicting a schema of an internal configuration of an ink-jet printer 1 according to the fourth modified example of the present disclosure. In FIG. 10, the fourth modified example is different from the second embodiment mainly in that the branching position of the first conveying route R1 and the third conveying route R3 is provided at a position upstream of the first conveying roller 60 in the conveying direction.

As depicted in FIG. 10, in the ink-jet printer 1 of the fourth modified example, it is configured such that the entire of the third conveying route R3 is arranged below the waste liquid box HB. That is, the guide member 73, 74, and 75, the third conveying roller 68, and the pinch roller 69, etc. is provided below the waste liquid box HB. In the third conveying route R3, the branching position Y at which the third conveying route R3 branches from the first conveying route R1 is set between the guide member 52 and the pinch roller 61.

Based on the above configuration, the fourth modified example achieves effects same as or similar to the effects achieved by the second embodiment. Further, in the fourth modified example, the entire of the third conveying route R3 is arranged in the back-surface-side-area of the housing 11A and below the waste liquid box HB. Thus, in the fourth modified example, the internal space of the housing 11A can be utilized efficiently because the waste liquid box HB is arranged in the housing 11A at an open space above the entire of the third conveying route R3. Therefore, in the fourth modified example, in a case that the entire of the third conveying route R3 is arranged in the back-surface-side-area of the housing 11A, it is possible to downsize the ink-jet printer 1 including the waste liquid box HB easily.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Note that, in the above, the case in which the ink absorbing foam HB2 is provided in the inside of the waste liquid case HB1 is described. However, embodiments of the present disclosure are not limited thereto. The configuration in which the ink absorbing foam HB2 configured to absorb the waste liquid is omitted may be adopted.

However, it is possible to increase a storing amount of the waste liquid box HB by providing the ink absorbing foam HB2 in the inside of the waste liquid case HB1. This is because, an amount of a liquid to be stored safely is increased by using the absorbing form that catches the liquid. As a result, it is possible to reduce frequency of replacing of the waste liquid box HB, and thus it is possible to easily configure the ink-jet printer 1 capable of simplifying the maintenance operation.

In the above, the configuration in which the waste liquid box HB and the maintenance unit 8 are connected via the tube 83 etc., and the ink etc. from the maintenance unit 8 is stored in the waste liquid box HB is described. However, the present disclosure is not limited thereto. The configuration in which the waste liquid box HB collects a waste liquid (the ink etc.) from other source may be adopted. Specifically, for example, it is possible to adopt the configuration in which a predetermined flushing area for receiving the ink etc. discharged in a flushing process is provided and the waste liquid box HB stores the ink etc. from the flushing area. Further, for example, it is possible to adopt the configuration in which the ink etc. from the flushing area is absorbed by a dedicated ink absorbing foam provided in the housing 11A instead of the waste liquid box HB. The dedicated ink absorbing foam is an example of the waste liquid reservoir.

In the above embodiments and modified examples, the wording of “one component arranged above (or below) another component” includes a state in which one component and another component are overlapped with each other as seen in the up-down direction as well as a state in which one component and another component are not overlapped with each other as seen in the up-down direction.

The present disclosure is not limited to the embodiments described above, and can be modified in various manners within a range indicated by the claims. The configuration obtained by appropriately combining technical means disclosed in each embodiment is included in the scope of the present disclosure.

What is claimed is:

1. A liquid discharging apparatus comprising:
a housing;
a head including a nozzle configured to discharge a liquid to a printing medium;
a waste liquid reservoir configured to store a waste liquid of the liquid, the waste liquid reservoir being configured to be inserted into and drawn from the housing; and
a conveying route via which the printing medium is to be conveyed in a conveying direction,
wherein, in a state that the waste liquid reservoir is inserted in the housing, the waste liquid reservoir is arranged in an inside of the housing, and at a position upstream of the head in the conveying direction and above the conveying route.

2. The liquid discharging apparatus according to claim 1, wherein, in the state that the waste liquid reservoir is inserted in the housing, at least a portion of the waste liquid reservoir is arranged at a position where the at least the portion of the waste liquid overlaps with the head in an up-down direction orthogonal to a nozzle surface of the head.

3. The liquid discharging apparatus according to claim 2, further comprising a display panel configured to display information,
wherein the display panel is provided at a position downstream of the head in the conveying direction.

4. The liquid discharging apparatus according to claim 3, further comprising a reverse conveying route configured to be used for performing a double-sided printing to the printing medium,
wherein, in the state that the waste liquid reservoir is inserted in the housing, the waste liquid reservoir is arranged above the reverse conveying route.

5. The liquid discharging apparatus according to claim 3, further comprising a reader configured to read an object as an image,
wherein, in the state that the waste liquid reservoir is inserted in the housing, the waste liquid reservoir is arranged below the reader.

6. The liquid discharging apparatus according to claim 3, further comprising:
a carriage configured to move in a scanning direction, the head being mounted on the carriage; and
a guide rail extending along the scanning direction, the carriage being supported by the guide rail,
wherein the waste liquid reservoir is arranged upstream of the guide rail in the conveying direction.

7. The liquid discharging apparatus according to claim 6, further comprising a carriage motor configured to move the carriage in the scanning direction,
wherein, in the state that the waste liquid reservoir is inserted in the housing, the waste liquid reservoir is arranged in one of a right-side-area and a left-side-area of the housing, and the carriage motor is arranged in remaining one of the right-side-area and the left-side area-of the housing, in a left-right direction parallel with the nozzle surface of the head and orthogonal to the conveying direction.

8. The liquid discharging apparatus according to claim 3, further comprising a back-surface feeder provided in a back-surface-side-area of the housing, the back-surface feeder being configured to feed the printing medium to the conveying route,
wherein, in the state that the waste liquid reservoir is inserted in the housing, the waste liquid reservoir is arranged downstream of the back-surface feeder in the conveying direction.

9. The liquid discharging apparatus according to claim 3, further comprising:
a maintenance unit configured to perform maintenance for the head, and
a tube connecting the waste liquid reservoir and the maintenance unit,
wherein the tube is arranged along a side-surface of a main body of the housing.

10. The liquid discharging apparatus according to claim 9, wherein, in the state that the waste liquid reservoir is inserted in the housing, the waste liquid reservoir is arranged in one of a right-side-area and a left-side-area of the housing, and the maintenance unit is arranged in one of the right-side-area and the left-side-area of the housing same as the one of the right-side-area and the left-side-area of the housing in which the waste liquid reservoir is arranged, in a left-right direction parallel with the nozzle surface of the head and orthogonal to the conveying direction.

11. The liquid discharging apparatus according to claim 3, further comprising a conveying motor configured to convey the printing medium in the conveying route,
wherein, in the state that the waste liquid reservoir is inserted in the housing, the waste liquid reservoir is arranged in one of a right-side-area and a left-side-area of the housing, and the conveying motor is arranged in remaining one of the right-side-area and the left-side-area of the housing, in a left-right direction parallel with the nozzle surface of the head and orthogonal to the conveying direction.

12. The liquid discharging apparatus according to claim 3, further comprising the control board,
wherein, in the state that the waste liquid reservoir is inserted in the housing, the waste liquid reservoir is arranged below the control board.

13. The liquid discharging apparatus according to claim 12, further comprising a support which is arranged between the waste liquid reservoir and the control board, which has a shield configured to shield the waste liquid reservoir, and which supports the control board.

14. The liquid discharging apparatus according to claim 3, further comprising a jam treating mechanism provided in the conveying route, the jam treating mechanism being configured such that a jam of the printing medium caused in the conveying route is resolved via the jam treating mechanism,
wherein, in the state that the waste liquid reservoir is inserted in the housing, the waste liquid reservoir is arranged in right of the jam treating mechanism and/or in left of the jam treating mechanism in a left-right direction parallel with the nozzle surface of the head and orthogonal to the conveying direction.

15. The liquid discharging apparatus according to claim 1, wherein a lid configured to be opened and closed for inserting and drawing the waste liquid reservoir with respect to the housing is provided in a side-surface of the housing.

16. The liquid discharging apparatus according to claim 15, wherein the waste liquid reservoir includes a container, and an adsorbing foam configured to be arranged in an inside of the container, the absorbing foam being configured to absorb the waste liquid.
